(19) United States
(12) Patent Application Publication
(10) Pub. No.: US 2014/0133908 A1
(43) Pub. Date: May 15, 2014

(54) METHOD OF REDUCING ALKALI-SILICA REACTION FOR EMBEDDING AGGREGATE IN CONCRETE AND MITIGATING DETRIMENTAL EFFECTS OF FREEZE-THAW IN CONCRETE

(71) Applicant: LITHOCRETE, INC., Costa Mesa, CA (US)

(72) Inventor: RONALD SHAW, CORONA DEL MAR, CA (US)

(73) Assignee: LITHOCRETE, INC., Costa Mesa, CA (US)

(21) Appl. No.: 14/157,434

(22) Filed: Jan. 16, 2014

Related U.S. Application Data
(63) Continuation of application No. 13/441,133, filed on Apr. 6, 2012.

(51) Int. Cl. E01C 11/24; C04B 24/00; C04B 22/00

(52) U.S. Cl. CPC E01C 11/24; C04B 22/00; C04B 24/00
USPC 404/82

(57) ABSTRACT

A method for forming a concrete slab at a location subject to freezing temperatures is disclosed. Additionally, a method for forming a concrete slab with aggregate embedded at the exposed surface of the concrete slab is disclosed. The method contemplates utilization of a waterproof concrete mix.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

The methods and embodiments disclosed herein are directed to a concrete slab having a surface seeded aggregate and/or formed at a location subject to freezing temperatures.

Concrete slabs may be formed with embedded surface seeded aggregate at the exposed surface of the concrete slab. Various methods of embedding the aggregate into the exposed surface of the concrete slab are described in U.S. Pat. Nos. 6,033,136; 7,670,081; 7,607,859 and 7,614,820. These methods require an additional step of applying a chemical treatment of hydrolyzed alkali silica solution to the exposed surface of the concrete. The solution must be applied in a specific manner to prevent the detrimental effects between reactive aggregate and the concrete. The application of the hydrolyzed alkali silica solution assists in maintaining embedment of the exposed aggregate in the concrete slab even with high pedestrian traffic. If the hydrolyzed alkali silica solution is applied incorrectly, then the solution will be ineffective.

For example, the application of the solution must be uniform over the exposed surface. Moreover, the hydrolyzed alkali silica solution must penetrate through the exposed surface of the concrete slab to a particular depth. If the hydrolyzed alkali silica solution does not penetrate sufficiently deep into the exposed surface of the concrete slab then the aggregate may detach from the concrete slab as pedestrians walk over the aggregate due to the detrimental chemical reaction of reactive aggregate and the concrete. The solution must be applied at a certain temperature, specifically, between 50° F.-100° F. In cold environments, this means that the concrete slab with exposed surface seeded aggregate can only be formed during certain times of the year. Also, with the application of the hydrolyzed alkali silica solution, additional steps and care must be taken in curing the uncured concrete. The application of the hydrolyzed alkali silica solution also adds time and expense to the construction project since it is an extra step over and above forming the concrete and distributing the aggregate onto the concrete.

Concrete slabs are also formed in various environments. One environment in which concrete slabs do not particularly do well in is environments which reach freezing temperatures on a cyclical basis. The reason is that concrete stabs are porous which absorb water. When the water absorbed in the concrete slab freezes, the frozen water expands and applies pressure in the pores of the concrete. If the pressure exceeds the strength of the concrete, then the cavity will deteriorate. The cumulative effects of successive freeze-thaw cycles eventually create cracking, scaling, crumbling and eventual failure of the concrete slab. To address the detrimental effects of freeze-thaw damage, the concrete slab is entrained with a large number of closely spaced small air bubbles. The air bubbles relieve the pressure caused by ice formation by acting as expansion chambers. Unfortunately, this is an imperfect solution.

Accordingly, there is a need in the art for an improved method for addressing the issue of alkali silica reaction when embedding certain aggregate at the exposed surface of a concrete slab. There is also a need in the art for an improved method for resolving the detrimental effects of freeze-thaw and addressing both the issue of alkali silica reaction when embedding aggregate and freeze thaw.

### BRIEF SUMMARY

The various aspects disclosed herein address the needs discussed above, discussed below and those that are known in the art.

In the method disclosed herein, the method addresses the issue of alkali silica reaction when embedding reactive aggregate into a concrete slab. Instead of applying a hydrolyzed alkali silica solution to the exposed surface of the concrete slab, a waterproofing admixture is added to the concrete mix. This allows the construction of the concrete slab with exposed embedded concrete at temperatures below 50 degrees F and above 100 degrees F. Moreover, after uniformly mixing the waterproofing admixture to the concrete mix, the concrete mix is handled and cured as normal.

The mixture of waterproofing admixture and concrete mix may also be used to mitigate the detrimental effects of freeze-thaw. The concrete slab need not be entrained with air to relieve pressure caused by frozen ice.

The method disclosed herein includes the step of mixing a waterproofing admixture with the concrete mix to produce a waterproof concrete mix. The waterproof concrete mix may be utilized to address one or both of (1) alkali silica reaction when embedding reactive aggregate in concrete and/or (2) the freeze thaw issue. By way of example and not limitation, the waterproof concrete mix (i.e., mixture of waterproofing admixture and concrete mix) may be used to form the concrete slab at a location subject to freezing temperatures and to address the detrimental effects of the freeze-thaw without embedding aggregate at the exposed surface thereof. Additionally, the waterproof concrete mix may be utilized to form a concrete slab at a location subject to freezing temperatures with aggregate embedded at that exposed surface of the concrete slab all without entraining the concrete slab with air or utilizing a surface retarder as discussed in the prior art references. The waterproof concrete mix may also be utilized in locations not subject to freezing temperatures embed aggregate at the exposed surface of the concrete slab. The waterproof concrete mix is versatile in that it can be utilized to address one or both of the freeze-thaw issue or facilitate embedment of aggregate at the exposed surface of the resulting concrete slab.

More particularly, a method of producing a concrete slab having an exposed surface seeded aggregate is disclosed. The method may comprise the steps of providing a concrete mixture having a waterproof admixture to produce a waterproof concrete mix; after the providing step, pouring the waterproof concrete mix over the subgrade, the waterproof concrete mix defining an exposed surface when poured; bringing up a quantity of cement/fines paste to the exposed surface of the waterproof concrete mix; broadcasting a quantity of aggregate upon the exposed surface of the waterproof concrete mix; mixing the quantity of aggregate into the quantity of cement/fines paste; and curing the waterproof concrete mix.

The aggregate used in the method may be selected from the group consisting of glass, silica glass, organic materials, sea shells, coarse sand, Monterey Aquarium coarse sand and mollusk. The aggregate used in the method may be prone to alkali-silica reaction. The waterproofing admixture mitigates the alkali-silica reaction between the alkali-silica prone aggregate and the concrete mixture to facilitate secure embedment of the alkali-silica prone aggregate in the concrete slab. The aggregate used in the method may be glass, silica glass, organic materials, sea shells of marine animals and mollusk, metal, composite materials and combinations thereof.

In the method, the bringing up step may be accomplished with a vibrating metal bull float. In the method, the mixing step may be accomplished with a vibrating metal bull float.

The method may further comprise the step of finishing the exposed surface of the concrete mixture with a power trowel to facilitate an even distribution of the quantity of aggregate within the quantity of cement/fines paste.

In the method, the pouring step may include the step of pouring the waterproof concrete mix over the subgrade at a location subject to freezing temperature, wherein the waterproofing admixture mitigates detrimental effects of freeze thaw on the concrete slab.

In another aspect, a method of forming a concrete slab which mitigates detrimental effects of freeze-thaw is disclosed. The method may comprise the steps of forming a subgrade at a location subject to freezing temperatures; providing a concrete mixture having a waterproof admixture to produce a waterproof concrete mix; after the providing step, pouring the waterproof concrete mix over the subgrade at a location subject to freezing temperatures, wherein the waterproofing admixture mitigates detrimental effects of freeze thaw to the concrete slab.

In the method, the waterproofing admixture may transform into a polymer to mitigate absorption of water into the concrete slab. Alternatively, the waterproofing admixture may generate a crystalline formation to mitigate absorption of water into the concrete slab.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is flow chart for mixing a water proof admixture and concrete mixed to produce a waterproof concrete mix which is subsequently used to form a concrete slab;

FIG. 2 illustrates a flow chart for forming a concrete slab at a location subject to freezing temperatures and mitigating the detrimental effects of freeze-thaw;

FIG. 3 is a cross-sectional view of a concrete slab formed at a location subject to freezing temperatures to address the detrimental effects of freeze-thaw;

FIG. 4 illustrates a flow chart of a method for embedding aggregate upon an exposed surface of a concrete slab; and

FIG. 5 is a cross sectional view of the concrete slab with embedded exposed surface seeded aggregate using the method shown in FIG. 4.

### DETAILED DESCRIPTION

Referring now to the drawings, the method disclosed herein utilizes a water proofing admixture 10 which is mixed in with a concrete mix 12 for the purposes of facilitating embedment of aggregate 16 into an exposed surface 18 of the concrete slab 14a and/or preventing cracks in a concrete slab 14, 14a due to freeze-thaw. The resultant mixture of the waterproofing admixture 10 and concrete mix 12 shall be referred to as waterproof concrete mix 20. Once the water proofing admixture 10 and the concrete mix 12 are homogenously mixed, the waterproof concrete mix 20 is poured over a sub-grade 22 to form 50 a concrete slab 24, 24a. The concrete slab 24, 24a to be formed with the waterproof concrete mix 20 may be formed at a location subject to freezing temperatures. The waterproofing admixture 10 prevents absorption of water or liquid into the concrete slab 24, 24a. As such, when the environmental temperature reaches freezing temperatures, no liquid is disposed within the concrete slab 24, 24a and the concrete slab 24, 24a does not experience the detrimental effects of repeated freeze-thaw cycles. If aggregate 16 is surface seeded into the concrete slab 24a, then a vibrating metal bull float is worked on the exposed surface 18 after pouring the waterproof concrete mix 20 over the sub-grade 22 to dispose a quantity of cement/fine paste 26 of the waterproof concrete mix 20 at the exposed surface 18. A quantity of aggregate 16 is then disposed over the exposed surface 18 and evenly distributed thereon. The aggregate 16 is mixed into the cement/fines paste 26. The waterproof concrete mix 20 is then allowed to cure to form the concrete slab 24a. The aggregate is now embedded at the top surface of the concrete slab. No special care need be taken other than to embed the concrete and cure the concrete. The method of forming the concrete slab 24, 24a may be utilized in all location including locations that reach freezing temperatures as well as those that do not. Moreover, the method disclosed herein permits formation of a concrete slab 24a with surface seeded aggregate 16 not only in moderate temperature locations but also in locations which reach freezing temperatures. Moreover, the method disclosed herein for embedding surface seeded aggregate 16 into the concrete slab 24a does not require application of a hydrolyzed alkali silication solution and the special care of applying such solution.

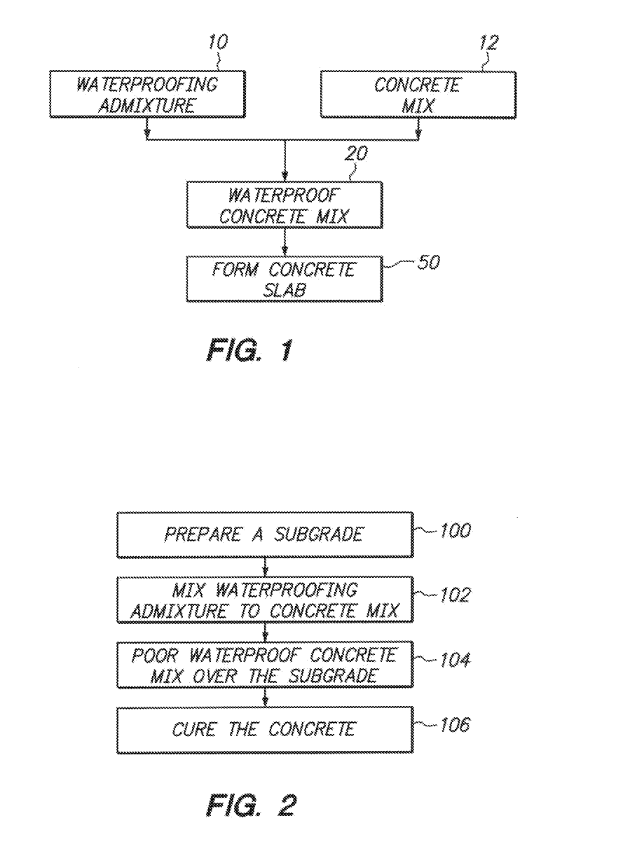

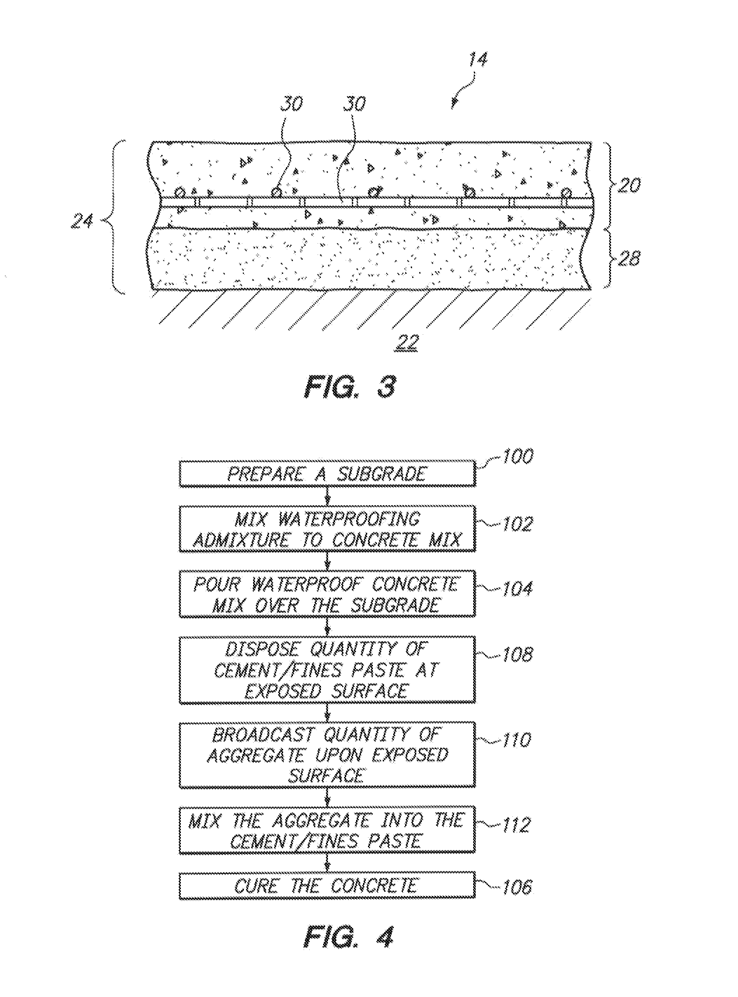

More particularly, referring now to FIGS. 1-3, in preparing 100 a subgrade 22, the ground may be excavated to a desired elevation and grade. The subgrade 22 is preferably compacted to 90% compaction. A layer of clean, moist coarse sand 28 is preferably poured over the subgrade 22 and maintained at a minimum four (4) inch thickness. The sand 28 is not necessary for addressing freeze-thaw or producing the surface seeded aggregate concrete slab 24a but is preferable to control the hydration process of the concrete slab 24, 24a. If it is desired to increase the resultant strength of the concrete slab 24, 24a and reduce subsequent cracking of the same, reinforcement members 30 such as a wire mesh or rebar is/are positioned upon the layer of sand 28.

A water proofing admixture 10 is mixed 102 in with a concrete mix 12 to produce a waterproof concrete mix 20, as shown in FIG. 1. The admixture 10 may be provided in powder form and added to the drum of a ready-mix truck. The ready mix truck may be driven under a batch plant and the balance of the materials may be added to the ready mix truck in accordance with standard concrete practices. The admixture 10 and the concrete mix 12 may be mixed to ensure a homogenous mixture of the admixture 10 and the concrete mix 12. Alternatively, water may be added to the dry water proofing admixture 10 to form a slurry. The slurry is poured into the ready mix truck. The aggregate, cement and water are batched and mixed in accordance with cement practices taking into account the water that has already been placed in the ready mix truck. In a further alternative, the admixture 10 may be added to rock and sand and then mixed thoroughly to provide for a homogenous mixture. Cement and water are then added and blended using standard practices. Although the waterproofing admixture 10 may be mixed in with the concrete mix 12 at a batch plant, it is also contemplated that the waterproofing admixture 10 may be mixed in with the concrete mix 12 at the job site.

The water proofing admixture 10 may be an admixture sold under the trade name XYPEX admix or HYCRETE. By way of example and not limitation, the waterproofing admixture 10 may transform into a polymer to mitigate absorption of water into the concrete slab 24, 24a. Alternatively, the waterproofing admixture 10 may generate a crystalline formation to mitigate absorption of water into the concrete slab 24, 24a.

The waterproof concrete mix 20 is poured 104 over the subgrade 22 to approximately 3 ½ to 4 inch thickness. If fill sand 28 and reinforcement members 30 are used, then the waterproof concrete mix 20 is poured 104 over the layer of fill sand 28 and the reinforcement members 30 such that the reinforcement members 30 are encapsulated within the waterproof concrete mix 20. After the waterproof concrete mix 20 has been poured 104 on the subgrade 22, the uncured concrete is preferably screeded to a desired level plane or grade. The screeding of the concrete mixture results in defining a generally level or planar upper exposed surface 18. The concrete mixture may be cured 106 according to standard practices. When the above concrete slab 24 is formed at a location subjected to the detrimental effects of freeze-thaw, the concrete slab 24 which is now waterproof prevents entrapment of water in the pores of the concrete slab 24 to mitigate the detrimental effects of freeze-thaw.

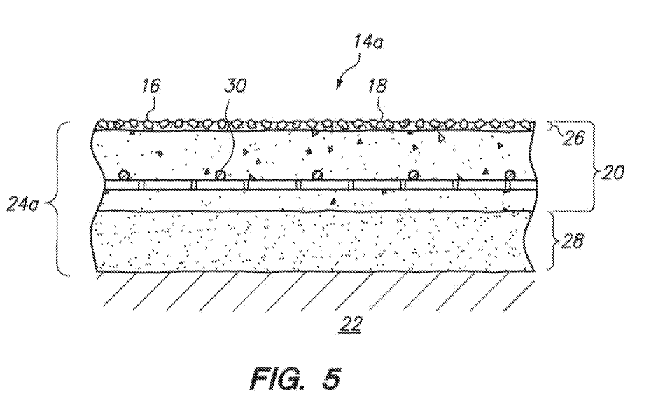

The above concrete slab 24 mitigates the detrimental effects of freeze-thaw. Moreover, referring now to FIGS. 4 and 5, a concrete slab 24a with embedded aggregate may be formed utilizing the waterproofing admixture 10 wherein the surface seeded concrete slab 24a may be formed in locations subject to freezing temperatures as well as non freezing temperatures. To this end, the subgrade 22 is prepared 100 in much the same way as discussed above. Additionally, the waterproof concrete mix 20 is prepared 102 in the same way as discussed above. Put simply, the waterproofing admixture 10 is mixed 102 homogenously into the concrete mix 12 prior to pouring the waterproof concrete mix 20 over the subgrade 22. After adding the waterproofing admixture 10 with the concrete mix 12, the waterproof concrete mix 20 is poured 104 over the subgrade 22 and if used, the fill sand 28 and reinforcement members 30 so that the waterproof concrete mix 20 encapsulates the reinforcement members 30.

The uncured concrete is screeded to a desired level plane or grade so as to define the exposed surface 18. The uncured concrete is not tamped as is conventional in the art. Tamping should be avoided so as to not bring up too much cement/fines paste 26 in the waterproof concrete mix 20 which would be prohibitive for the subsequent surface seeding of the exposed aggregate 16 thereupon. Rather, after screeding, the exposed surface 18 of the uncured concrete is surfaced or finished with a vibrating bull float to dispose a quantity of cement/fines paste 26 derived from the waterproof concrete mix 20 at the exposed surface 18 as shown in FIG. 5. The vibrating metal bull float is characterized by possessing an extremely smooth or polished surface which seals the exposed surface 18 and also brings up 108 the appropriate amount of cement/fines paste 26. By way of example and not limitation, the vibrating metal bull float may be a vibrating magnesium or aluminum bull float. The vibrating metal bull float may be a float sold under the trademark HAL 200 by the Lievers Holland company.

After bringing up 108 the cement/fines paste 26 as discussed above and while the uncured concrete 20 is still plastic, small sized aggregate 16 is distributed 110 over the exposed surface 18 of the uncured concrete 20. The aggregate 16 may have a mean diameter size of about ⅜ inch or smaller. By way of example and not limitation, the mean diameter size may be about ⅜ inch, ¼ inch or ⅛ inch. The aggregate 16 may or may not be susceptible to alkali silica reactivity. By way of example and not limitation, the aggregate 16 may be silica sand, glass bead, coarse sand such as Monterey Aquarium coarse sand, organic materials such as sea shells, metals, or composite materials. The aggregate 16 may also be susceptible to alkali-silica reactivity such as glass, silica glass, organic materials, sea shells of marine animals, mollusk, metals and composite materials. Although the aggregate 16 may be susceptible to alkali-silica reactivity, the method disclosed herein mitigates alkali-silica reactivity due to the waterproofing admixture 10 in the concrete mix 12. Alternatively, the aggregate may be an aggregate that is not prone to alkali-silica reactivity such as coarse sand, Monterey Aquarium (Grade) coarse sand. The aggregate 16 may have rough jagged, sharp or round smooth external surfaces.

The aggregate 16 is distributed 110 over the exposed surface 18 of the uncured concrete 20 at a preferred rate of about 1 pound per square foot of the exposed surface 18 of the uncured concrete 20. During this broadcasting step 110, the aggregate 16 should preferably not initially depress below the exposed surface 18 of the uncured concrete 20 but be distributed to solely cover the exposed surface 18. The distribution of the aggregate 16 is preferably done in an even manner. The aggregate 16 may be distributed 110 with a square tip shovel when distributing 110 aggregate 16 up to 10 feet away from the person operating the shovel. When the aggregate 16 needs to be distributed 110 over a large surface area or more than 10 feet and up to 24 feet away from the operator, the aggregate 16 may be distributed 110 utilizing a material spraying device such as a Goldblat material sprayer or a sand blaster. Use of a material spraying device allows for a uniform distribution of the aggregate 16 equal to or better than the uniformity achievable through manual distribution with a square point shovel.

Although an even distribution of aggregate 16 is contemplated, it is also contemplated that a non even distribution of aggregate 16 may be disposed over the uncured concrete 20. By way of example and not limitation, the aggregate 16 may be formed over a small patch on the uncured concrete. Alternatively, the aggregate 16 may be disposed over the uncured concrete 20 in the form of a letter or other pattern.

Subsequent to broadcasting 110 the aggregate 16, the aggregate 16 is then worked into 112 the cement/fines paste 26 that was previously brought up 108 to the exposed surface 18 of the uncured concrete 20. To this end, the vibrating metal bull float (e.g., magnesium or aluminum) may be used to work 112 the aggregate 16 into the cement/fines paste 26 to ensure that the aggregate 16 is fully embedded into the cement/fines paste 26, and thus, thoroughly adhered or bonded to the exposed surface 18 of the cured concrete.

After working or embedding 112 the aggregate 16 into the cement/fines paste 16, the exposed surface 18 may be finished with a power trowel to further facilitate even distribution of the aggregate 16 within the cement/fines paste 26.

After finishing the exposed surface 18 with the power trowel, a vapor barrier is preferably formed on the exposed surface 18 of the uncured concrete 20. By way of example and not limitation, the formation of the vapor barrier may be facilitated by the application of a liquid chemical evaporation reducer to the exposed surface of the uncured concrete. A preferred evaporation reducer is sold under the trademark CONFILM by the Concrete Tie company of Compton, Calif.. Alternatively, a vapor barrier may be formed by covering the exposed surface with four or six mill visqueen. The vapor barrier may be maintained upon the exposed surface of the uncured concrete 20 for a prescribed period of time, which may range from approximately two to twenty-four hours.

After the vapor barrier has remained upon the exposed surface 18 for the prescribed period of time, the exposed surface 18 of the uncured concrete 20 is washed with water to remove any surface films. The washing procedure may also include the step of lightly brushing the exposed surface 18 with a bristle. The brushing is preferably performed so that no more than about 5% of the aggregate 16 is dislodged and removed from the exposed surface 18. The extremely low percentage (i.e., less than 5%) removal of the aggregate 16 from the exposed surface 18 evidences the extremely strong adherence of the aggregate 16 to the exposed surface 18 of the concrete. The application of the liquid evaporation reducer to the exposed surface 18 which prevents hydration of the uncured concrete and reduces the rate of evaporation of moisture from the uncured concrete 20 increases the ease at which excess cement/fines paste 26 are washed from the exposed surface 18 during this initial washing step.

After washing, the concrete mixture 16 may be cured 106 with water only as opposed to chemical curing agents to avoid any staining of the same. Water curing 106 may be facilitated through the use of a conventional fogger or soaker hose. After a prescribed period of time (e.g., 30 days after initiating the curing process) any surface residue present on the exposed surface 18 may be removed by conventional power washing with a 90% steam and 10% muriatic acid mixture which is applied by a power washer via a high pressure nozzle.

The resultant surface seeded exposed aggregate concrete exhibits an extremely flat exposed aggregate surface which is suitable for extremely high pedestrian traffic flooring applications. Additionally, exposed surface of the concrete slab may be modified in that the surface color and texture approximates the surface color and texture of more conventional flooring surfaces such as stone, granite and marble. This resemblance can further be accentuated by saw cutting the concrete surface into rectangular grids to give the appearance that the individual rectangular squares of the grid were laid in a manner analogous to stone, granite or marble flooring.

The addition of the waterproofing admixture 10 to the concrete mix 12 mitigates the detrimental effects of freeze-thaw in concrete slabs for locations that reach freezing temperatures. Moreover, the addition of the waterproofing admixture 10 to the concrete mix 12 also mitigates alkali-silica reaction when alkali-silica reaction prone aggregate 16 is surface seeded into the concrete slab. The alkali-silica reaction is formed between the chemical reaction between the concrete mix 12 and aggregate 16 that is susceptible to alkali-silica reactivity. The waterproofing admixture 10 mitigates the alkali silica reaction when alkali silica reaction prone aggregate 16 is used so that a surface retarder is not needed to ensure secure embedment of the aggregate 16 into the concrete slab. The waterproofing admixture 10 helps to ensure that the surface seeded aggregate remains embedded in the concrete even with high pedestrian traffic application. Also, waterproofing admixture also mitigate the detrimental effects of freeze-thaw.

The method disclosed herein may be useful for forming a concrete slab 24, 24a with or without aggregate 16 embedded in the exposed surface 18 regardless of whether the concrete slab 24, 24a is formed at locations subject to freezing temperatures. However, the method disclosed herein allows a contractor to form a concrete slab 24a with surface seeded aggregate 16 at a location subject to freezing temperature by addressing both 1) the embedment of the aggregate 16 in the concrete slab 24a and 2) mitigating the detrimental effects of freeze thaw simultaneously instead of separately with two different processes.

In the method described herein, the vibrating metal bull float may be replaced with any type of float such as a bull float, metal bull float and a wooden float. By use of the term vibrating metal bull float or any specific type of float herein, the various aspects disclosed herein should not be limited to the same but the method may incorporate the use of other types of floats known in the art or developed in the future.

The above description is given by way of example, and not limitation. Given the above disclosure, one skilled in the art could devise variations that are within the scope and spirit of the invention disclosed herein, including various ways of Mixing the waterproofing admixture and concrete mix together. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A method of producing a concrete slab having an exposed surface seeded aggregate, the method composing the steps of:
providing a concrete mixture having a waterproof admixture to produce a waterproof concrete mix;
after the providing step, pouring the waterproof concrete mix over the subgrade, the waterproof concrete mix defining an exposed surface when poured;
bringing up a quantity of cement/fines paste to the exposed surface of the waterproof concrete mix;
broadcasting a quantity of aggregate upon the exposed surface of the waterproof concrete mix;
mixing the quantity of aggregate into the quantity of cement/fines paste; and
curing the waterproof concrete mix.

2. The method of claim 1 wherein the aggregate is selected from the group consisting of glass, silica glass, organic materials, sea shells, coarse sand, Monterey Aquarium coarse sand and mollusk.

3. The method of claim 1 wherein the aggregate is prone to alkali-silica reaction and the waterproofing admixture mitigates the alkali-silica reaction between the alkali-silica prone aggregate and the concrete mixture to facilitate secure embedment of the alkali-silica prone aggregate in the concrete slab.

4. The method of claim 3 wherein the aggregate is glass, silica glass, organic materials, sea shells of marine animals and mollusk, metal, composite materials and combinations thereof.

5. The method of claim 1 wherein the bringing up step is accomplished with a vibrating metal bull float.

6. The method of claim 1 wherein the mixing step is accomplished with a vibrating metal bull float.

7. The method of claim 1 further comprising the step of finishing the exposed surface of the concrete mixture with a power trowel to facilitate an even distribution of the quantity of aggregate within the quantity of cement/fines paste.

8. The method of claim 1 wherein the pouring step includes the step of pouring the waterproof concrete mix over the subgrade at a location subject to freezing temperature, wherein the waterproofing admixture mitigates detrimental effects of freeze thaw on the concrete slab.

9. A method of forming a concrete slab which mitigates detrimental effects of freeze-thaw, the method comprising the steps of:
forming a sub-grade at a location subject to freezing temperatures;
providing a concrete mixture having a waterproof admixture to produce a waterproof concrete mix;
after the providing step, pouring the waterproof concrete mix over the subgrade, wherein the waterproofing admixture mitigates detrimental effects of freeze thaw on the concrete slab.

10. The method of claim 9 wherein the waterproofing admixture transforms into a polymer to mitigate absorption of water into the concrete slab.

11. The method of claim 9 wherein the waterproofing admixture generates a crystalline formation to mitigate absorption of water into the concrete slab.
